(19) United States
(12) Patent Application Publication
(10) Pub. No.: US 2022/0081971 A1
(43) Pub. Date: Mar. 17, 2022

(54) FOLDING SAFETY GATE

(71) Applicant: SUMMER INFANT (USA), INC., Woonsocket, RI (US)

(72) Inventors: Mitchell Shellenberger, Mount Joy, PA (US); Dana E. Chicca, Somerset, MA (US); Paul MacPhail Brown, Swansea, MA (US)

(21) Appl. No.: 17/474,821

(22) Filed: Sep. 14, 2021

Related U.S. Application Data
(60) Provisional application No. 63/109,431, filed on Nov. 4, 2020.
(60) Provisional application No. 63/077,880, filed on Sep. 14, 2020.

(51) Int. Cl. E06B 11/02; E05B 65/00

(52) U.S. Cl. CPC E06B 11/022; E06B 2009/002; E05B 65/0014

(57) ABSTRACT

A folding safety gate includes a pass through door, and an L-frame, the pass through door linked to the L-frame, the L-frame comprising a vertical section and a horizontal section, the pass through door hinged to the vertical section by an upper hinge and a lower hinge, the horizontal section spanning a gap from a bottom of the vertical section to an opposite side on the pass through door and configured to unlatch and fold vertically.

### CROSS REFERENCE TO RELATED APPLICATIONS

This application claims benefit from U.S. Provisional Application Ser. No. 63/077,880, filed Sep. 14, 2020, and U.S. Provisional Application Ser. No. 63/109,431, filed Nov. 4, 2020, which are both incorporated by reference in their entireties.

### BACKGROUND OF THE INVENTION

The present invention relates generally to barriers, and more particularly to a folding safety gate.

In general, child and pet safety gates are used to present a barrier to young children and pets to protect their health and safety.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a folding safety gate including a pass through door, and a L-frame, the pass through door linked to the L-frame, the L-frame including a vertical section and a horizontal section, the pass through door hinged to the vertical section by an upper hinge and a lower hinge, the horizontal section spanning a gap from a bottom of the vertical section to an opposite side on the pass through door and configured to unlatch and fold vertically.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is an illustration of an exemplary folding safety gate.

FIG. 2 is an illustration of an L-frame.

FIG. 3 is an illustration of a latching device in a locked position.

FIG. 4 is an illustration of the latching device in an unlocked position.

FIG. 5 is another illustration of the latching device in an unlocked position.

FIG. 6 is an illustration of the folding safety gate in a folded position.

FIG. 7 is an illustration of an alternate embodiment eliminates need for the latching device.

FIG. 8 is an illustration of an alternate embodiment eliminates need for the latching device.

FIG. 9 is an illustration of an alternate embodiment eliminates need for the latching device.

FIG. 10 is an illustration of an alternate embodiment eliminates need for the latching device.

FIG. 11 illustrates a pass through door with a lever.

FIG. 12 illustrates a pass through door with a lever.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

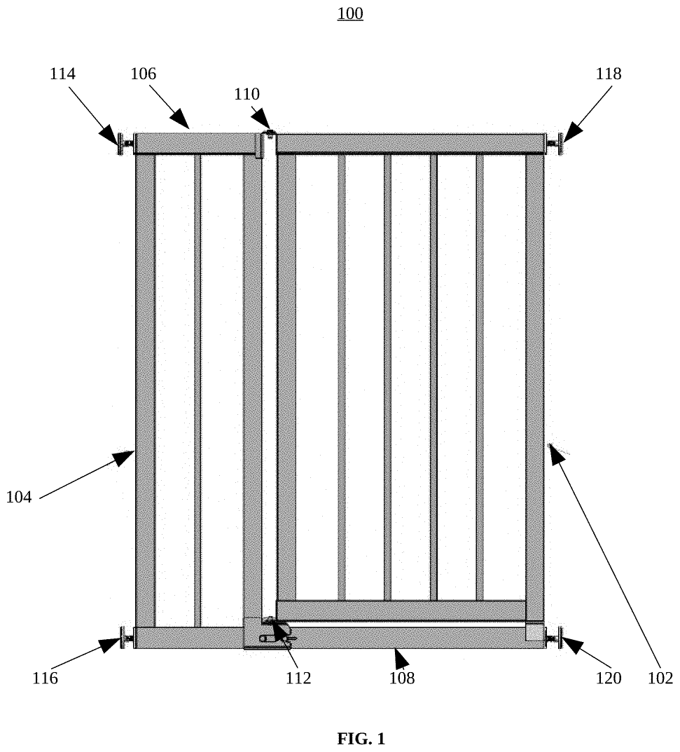

As shown in FIG. 1, an exemplary folding safety gate 100 includes a pass through door 102 linked to a L-frame 104. The L-frame 104 includes a vertical section 106 and a horizontal section 108. The pass through door 102 is hinged to the vertical section 106 by an upper hinge 110 and a lower hinge 112.

The horizontal section 108 spans a gap from a bottom of the vertical section 106 to an opposite side on the pass through door 102. As will be described below, the horizontal section 108 is constructed to enable it to unlatch and fold upwards for shipping or storage.

In one embodiment, the folding safety gate 100 contacts a doorway (not shown) with four points of contact 114, 116, 118, 120. The four points of contact 114, 116, 118, 120 are adjustable pressure pads so that when each is adjusted into a doorway, the pass through door 102 and L-frame 104 are secured in the doorway. This is generally referred to as pressure mounting. In alternate embodiments, the folding safety gate 100 employs hardware mounting, i.e., hardware is used to mount the folding safety gate 100 in a doorway.

As shown in FIG. 2, in an embodiment, the L-frame 104 includes three adjustable points of contact 200, 202, 204 that are used to secure it into a doorway. The horizontal section 108 includes a first section 206 and a second section 208 joined by a latching device 210.

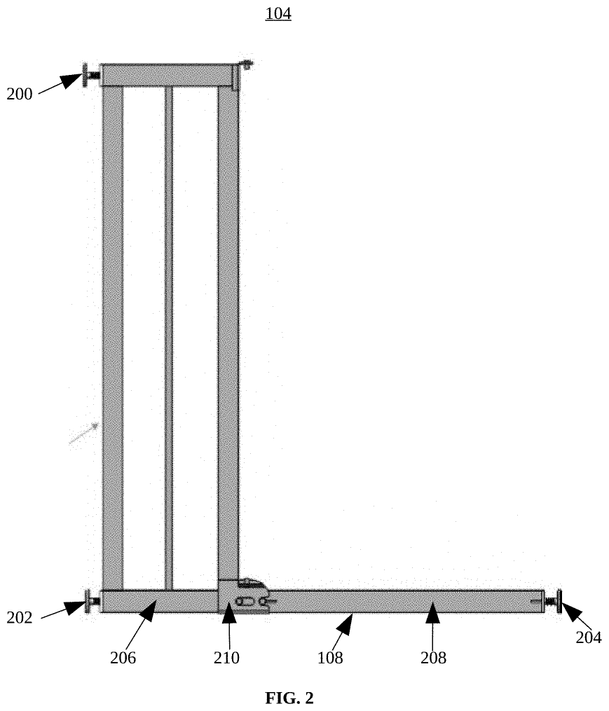

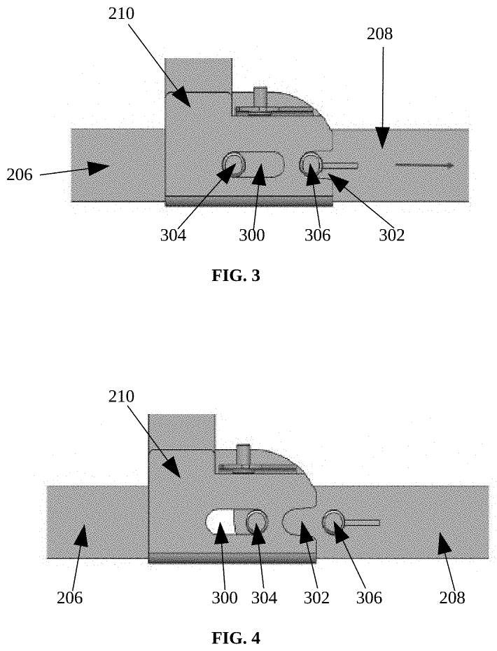

In FIG. 3, the latching device 210 is shown in a locked position. The latching device 210 includes a closed aperture 300 and an open-ended aperture 302. The second section 208 includes a first pin 304 and a second pin 306. Both the closed aperture 300 and an open-ended aperture 302 are configured to receive the first pin 304 and a second pin 306, respectively. When the second section 208 is pressed into the latching device 210, the first and second pins 304, 306 are wedged in the closed aperture 300 and an open-ended aperture 302 such that the second section 208 cannot rotate vertically. As such, the latching device 210 is in a locked position.

In FIG. 4, the latching device 210 is shown in an unlocked position. More specifically, when the L-frame 104 is removed from the doorway, the second section 208 is moved away from the latching device 210, the first pin 304 remains within the closed aperture 300 while the second pin 306 is exposed from the open-ended aperture 302 such that the second section 208 can rotate vertically about the first pin 304. As such, the latching device 210 is in an unlocked position.

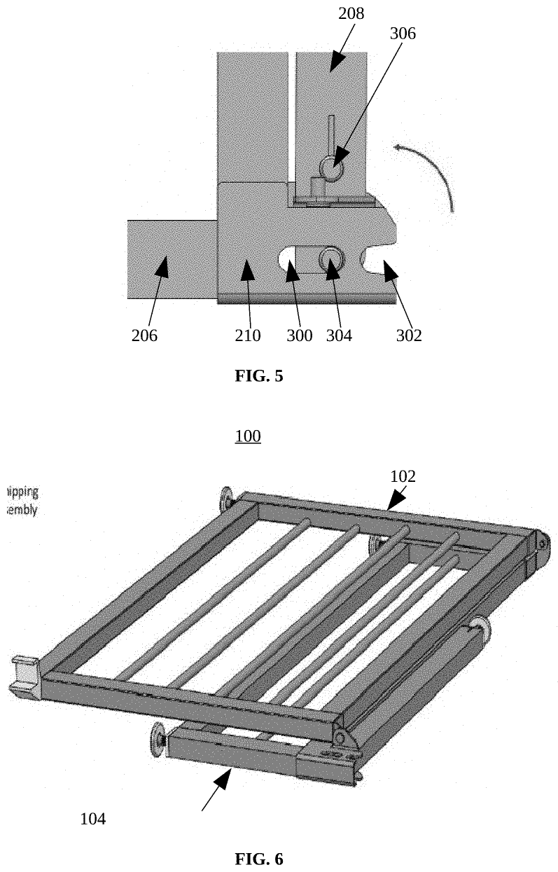

In FIG. 5, the latching device 210 is shown unlocked and the second section 208 shown rotated vertically about the first pin 304.

In FIG. 6, the folding safety gate 100 is in unlocked position with the pass through door 102 folded over linked the L-frame 104 and ready for storage, transportation or shipping.

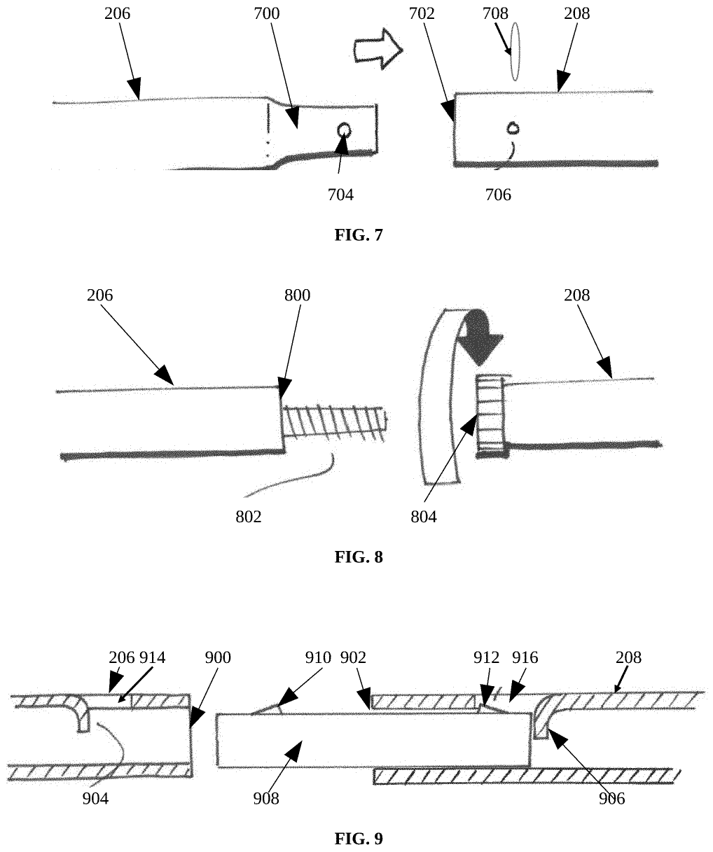

As shown in FIG. 7, an alternate embodiment eliminates need for the latching device 210, described above. More specifically, a proximal end 700 of the first section 206 is tapered to fit into an aperture 702 of the second section 208. The proximal end 700 includes a fastening opening 704 and the second section 208 a fastening opening 706. When the proximal end 700 is placed within the aperture 702, aligning the fastening opening 704 with the fastening opening 706 enables placement of a screw or Valco® pin (not shown) to secure the first section 206 in the second section 208.

As shown in FIG. 8, another alternate embodiment eliminates need for the latching device 210, described above. More specifically, a proximal end 800 of the first section 206 includes a protrusion 802 that is designed to be threaded into an aperture 804 of the second section 208. When the protrusion 802 is threaded into the aperture 804 the first section 206 becomes removably attached to the second section 208.

As shown in FIG. 9, another alternate embodiment eliminates need for the latching device 210, described above. More specifically, a proximal end of the first section 206 includes an aperture 900 and a proximal end of the second section 208 includes an aperture 902. A stop 904 is located within the aperture 900 and a stop 906 is located within the aperture 902. A joining section 908 includes opposing barbs 910, 912 that are designed to lock within corresponding slots 914, 916, respectively. Thus, when ends of the joining section 908 are placed into the apertures 900, 902, it butts up against the corresponding stops 904, 906 and the barbs 910, 912 lock into corresponding slots 914, 916.

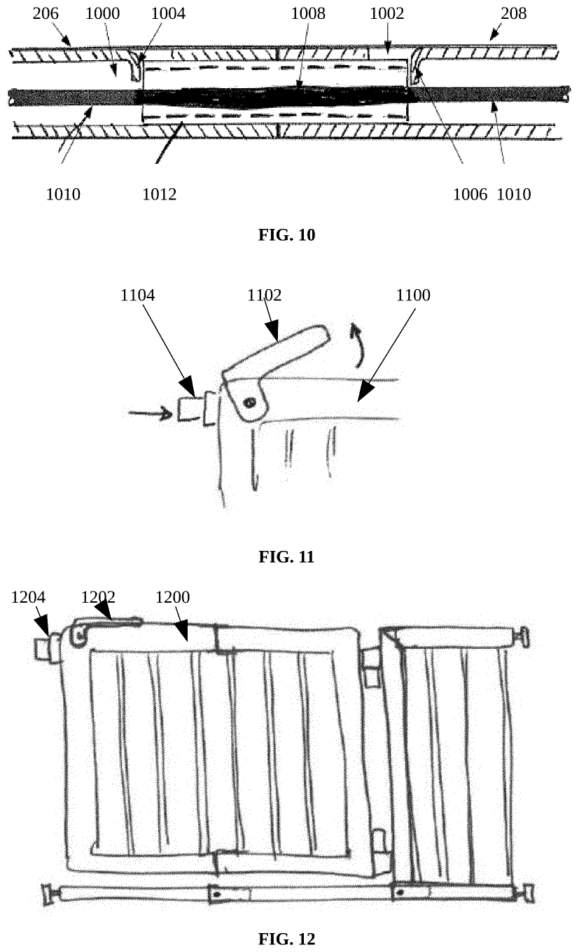

As shown in FIG. 10, yet another alternate embodiment eliminates need for the latching device 210, described above. More specifically, a proximal end of the first section 206 includes an aperture 1000 and a proximal end of the second section 208 includes an aperture 1002. A stop 1004 is located within the aperture 1000 and a stop 1006 is located within the aperture 1002. A joining section 1008 includes a bungee cord 1010 passing through a hollow tube 1012 such that when opposite ends of the joining section 1008 are placed into the aperture 1000, 1002, the first section 206 and the section 208 are held together.

As shown in FIG. 11, in an embodiment, a pass through door 1100 can include a lever 1102 that controls an upper adjustable pressure pad 1104. Pressing the lever 1102 downward causes the upper adjustable pressure pad 1104 to move out from the pass through door 1100 and press against a door frame (not shown). Lifting the lever 1102 upwardly causes the upper adjustable pressure pad 1104 to move out into the pass through door 1100 and thus away from the door frame (not shown).

FIG. 12 illustrates a pass through door 1200 having a lever 1202 that controls an upper adjustable pressure pad 1204.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A folding safety gate comprising:
a pass through door; and
an L-frame, the pass through door linked to the L-frame, the L-frame comprising a vertical section and a horizontal section,
the pass through door hinged to the vertical section by an upper hinge and a lower hinge,
the horizontal section spanning a gap from a bottom of the vertical section to an opposite side on the pass through door and configured to unlatch and fold vertically.

2. The folding safety gate of claim 1 wherein the horizontal section comprises a first section and a second section joined by a latching device.

3. The folding safety gate of claim 2 wherein the second section includes a first pin and a second pin.

4. The folding safety gate of claim 3 wherein the latching device includes a closed aperture and an open-ended aperture.

5. The folding safety gate of claim 4 wherein the closed aperture and an open-ended aperture are configured to receive the first pin and a second pin, respectively.

6. The folding safety gate of claim 5 wherein the first pin rotates in the closed aperture when in a locked position.

7. The folding safety gate of claim 1 wherein the horizontal section comprises:
a first section having a tapered proximal end; and
a second section having an aperture, the tapered proximal end of the first section configured to fit into the aperture.

8. The folding safety gate of claim 7 wherein the first section includes a first section fastening opening and the second section includes a second section fastening opening.

9. The folding safety gate of claim 8 further comprising a pin configured to fit into the first section and the second section when the first section fastening opening and the second section fastening opening are aligned.

10. The folding safety gate of claim 1 wherein the horizontal section comprises:
a first section having end protrusion; and
a second section having an aperture, the end protrusion of the first section configured to be threaded into the aperture of the section.

11. The folding safety gate of claim 1 wherein the horizontal section comprises:
a proximal end of the first section that includes an aperture having a first section stop positioned within;
a proximal end of the second section that includes an aperture having a second section stop positioned within; and
a joining section that includes opposing barbs configured to lock within corresponding slots of the first section aperture and the second section aperture and against the first section stop and the second section stop.

12. The folding safety gate of claim 1 wherein the horizontal section comprises:
a proximal end of the first section that includes an aperture having a first section stop positioned within;
a proximal end of the second section that includes an aperture having a second section stop positioned within; and
a joining section that includes a bungee cord passing through a hollow tube, the hollow tube configured together the first section and the second section such when opposite ends of the joining section are placed into the aperture of the first section and the aperture of the second section.

13. The folding safety gate of claim 1 further comprising a plurality of adjustable points of contact points configured to press against a vertical surface.

14. The folding safety gate of claim 13 wherein the plurality of adjustable points of contact points are adjustable pressure pads.

15. The folding safety gate of claim 14 further comprising a lever configured to control one of the plurality of adjustable pressure pads.

16. The folding safety gate of claim 15 wherein pressing the lever downward causes the one of the plurality of adjustable pressure pads to move out from the pass through door and press against a door frame, and lifting the lever upwardly causes the one of the plurality of adjustable pressure pads to move out into the pass through door and away from the door frame.
